(19) United States
(12) Patent Application Publication
(10) Pub. No.: US 2013/0240062 A1
(43) Pub. Date: Sep. 19, 2013

(54) DEVICE FOR THE MEDIA-TIGHT CONNECTION OF TWO HIGH-PRESSURE COMPONENTS

(71) Applicant: Reinhard Hoss, Plochingen (DE)

(72) Inventor: Reinhard Hoss, Plochingen (DE)

(21) Appl. No.: 13/883,160

(22) PCT Filed: Sep. 21, 2011
(86) PCT No.: PCT/EP2011/066417

§ 371 Date: May 31, 2013

(30) Foreign Application Priority Data
Nov. 4, 2010 (DE) 102010043366.7

(51) Int. Cl. B01D 25/00

(52) U.S. Cl. CPC B01D 25/00
USPC 137/544

(57) ABSTRACT

A device for the media-tight connection of two high-pressure components includes: a sealing cone having a central channel through which a medium under high pressure may flow, which sealing cone is pressed into a seal seat in order to seal against the medium which is under high pressure, and a high-pressure filter is accommodated in the channel in the sealing cone.

### BACKGROUND OF THE INVENTION

1. Field of the Invention

The present invention relates to a device for the media-tight connection of two high-pressure components.

2. Description of the Related Art

High-pressure components are used, for example, in auto-igniting internal combustion engines in which fuel under high pressure is injected into the individual combustion chambers of the internal combustion engine. For this purpose, the so-called “common rail technology” is used, in which fuel under high pressure is stored at essentially constant pressure in a high pressure store. The individual combustion chambers of the internal combustion engines are supplied with fuel via the high pressure store.

Testing facilities containing the corresponding high-pressure components are also used to test the individual components.

Since the individual high-pressure components used are sensitive to contaminants, high-pressure filters are generally installed in adapters in the inlet lines to the high-pressure components. The high-pressure filters remove particles contained in the liquid under high pressure, which flows through the high-pressure components, or contained in the liquid which is present in the high-pressure components. In addition to the use of high-pressure filters in adapters which are inserted into the inlet lines, filters are also sometimes mounted directly in high-pressure components, for example in a pressure control valve.

To ensure media seal-tightness at pressures of greater than 250 MPa, a grip edge is usually integrated into a high-pressure component which, during assembly of the high-pressure components, cuts into a surface of the mating part to which the high-pressure component is connected. This results in a groove in the surface of the mating part, which is generally a second high-pressure component. In addition, the grip edge also deforms. The surface of the second high-pressure component is damaged due to the cutting by the grip edge. If it is necessary to remove or replace one of the high-pressure components due to wear, soiling, repairs, or the like, each additional time the first high-pressure component is fastened to the second high-pressure component, the groove resulting from the cutting by the grip edge is further deepened, and the second high-pressure component is further damaged. After a limited number of assemblies and disassemblies, it is no longer possible to ensure an adequate seal, and the high-pressure component having the smooth surface, generally the high pressure store, must be replaced.

In particular when the high pressure store is used for testing purposes in a laboratory, individual components which are tested are regularly exchanged. This quickly results in damage to the high pressure store, thus necessitating replacement. In addition, components such as pressure control valves, which have an integrated filter, must be regularly removed to clean the filter. This also results in damage to the high pressure store. Another disadvantage of the required frequent removal of the pressure control valves is that additional components are required, which increases the costs for the testing.

The use of high-pressure filters which are inserted into adapters mounted in the inlet lines requires additional sealing points. In particular when the high-pressure components are used for testing, rigid lines, which are necessary for the use of high-pressure filters installed in adapters, are impractical due to the frequent changing of test pieces, in particular the injection pumps.

### BRIEF SUMMARY OF THE INVENTION

A device according to the present invention for the media-tight connection of two high-pressure components includes a sealing cone having a central channel through which a medium under high pressure may flow, the sealing cone being pressed into a seal seat in order to seal against the medium which is under high pressure, and a high-pressure filter being accommodated in the channel in the sealing cone.

The use of a sealing cone which is mounted in the area of the connecting point of two high-pressure components has the advantage that with the aid of the sealing cone, on the one hand a media-tight connection is achieved, and on the other hand, particles contained in the liquid flowing through the sealing cone are directly removed due to the high-pressure filter which is integrated into the sealing cone. Another advantage of using a sealing cone is that it may be easily removed during disassembly of the high-pressure components, for example in order to clean the high-pressure filter, or alternatively, to replace the sealing cone when the high-pressure filter becomes soiled. As the result of using the sealing cone, which is not provided with a grip edge, the surface of the second high-pressure component is not damaged, and the sealing cone may be replaced as often as desired.

The high-pressure filter is fastened in the sealing cone by force-fitting, for example. Alternatively, it is possible to weld the high-pressure filter into the sealing cone, in particular when a high-pressure filter made of metal is used. In addition, the high-pressure filter may be screwed in or fastened in the sealing cone in any other desired manner.

In a first specific embodiment, the sealing cone is designed as a taper, and has an opening angle that is 0.5° to 5°, preferably 1° to 3°, for example 2°, smaller than the opening angle of the seal seat. In one particularly preferred specific embodiment, the sealing cone has a taper of 58°, and the seal seat correspondingly has an angle of 60°. Alternatively, for example, an angle of 43° for the sealing cone and an angle of 45° for the seal seat are also preferred.

In one alternative, particularly preferred specific embodiment, the sealing cone has a convex shape. To achieve a tight fit, it is preferred that the radius of the convex surface be larger than the height of the sealing cone. In general, only a slight convex curvature is sufficient. As a result of the convex shape of the sealing cone, a more uniform stress on the seal seat is achieved, since a uniform contact against the seal seat is ensured due to the convex shape. On account of the convex shape, larger tolerances may be compensated for than with a conical sealing cone.

To connect the two high-pressure components to one another it is possible, for example, to form a thread on each of the high-pressure components and to screw the components together, in this case the sealing cone being inserted into a recess between the high-pressure components. Alternatively, it is possible, for example, to provide an external thread on the first high-pressure component, and to provide an enlargement on the second high-pressure component, the second component being enclosed by a union nut, and for the connection, the union nut resting on the enlargement of the second high-pressure component and being screwed onto the first high-pressure component via the thread in such a way that a contact force necessary for the sealing is applied to the sealing cone, which is positioned at the connecting point of the first high-pressure component and the second high-pressure component. For the assembly, it is also possible that the enlargement is not provided directly on the second high-pressure component, but instead is an end face of a pressure ring which is screwed onto the first high-pressure component.

If the sealing cone having the integrated high-pressure filter is used as a wear and tear part, it is possible, for example, for the sealing cone to have a side with a conical shape, as well as a flat surface. The conical side of the sealing cone is placed into a seal seat. For example, a grip edge of the first or the second high-pressure component acts on the smooth surface of the sealing cone. Replacement of the sealing cone does not further deepen the groove which results from the action by the grip edge, so that a tight connection between the first high-pressure component and the second high-pressure component is always achieved by using a new sealing cone in each case.

In an alternative specific embodiment, the sealing cone is designed as a double cone. In this case, a conical seal seat is provided in the first high-pressure component as well as in the second high-pressure component, and the sealing cone is inserted into the seal seat in each case. The media-tight connection is achieved by force-fitting the sealing cone into the particular seal seat.

To connect the first high-pressure component and the second high-pressure component, a first taper of the double cone is force-fitted into a first seal seat on the first high-pressure component, and a second taper of the double cone is force-fitted into a second seal seat on the second high-pressure component. The first high-pressure component and the second high-pressure component may once again be connected, for example, by screwing the two components together, either directly or with the aid of a union nut.

Metallic materials are particularly suited as a material for producing the sealing cone. Alternatively, however, it is also possible to form the seal seat from a ceramic material, for example. The material used must be stable against the pressure which acts on the sealing cone, and must also withstand a compressive force resulting from pressing the sealing cone against the particular seal seat.

In one particularly preferred specific embodiment, the first high-pressure component is a high pressure store, and the second high-pressure component is a supply line to the high pressure store or an inlet to a pressure control valve that is connected to the high pressure store. The high pressure store may be a high pressure store in an auto-igniting internal combustion engine in a vehicle, or may be a high pressure store for a testing device for injection nozzles or other high-pressure components.

### DETAILED DESCRIPTION OF THE DRAWINGS

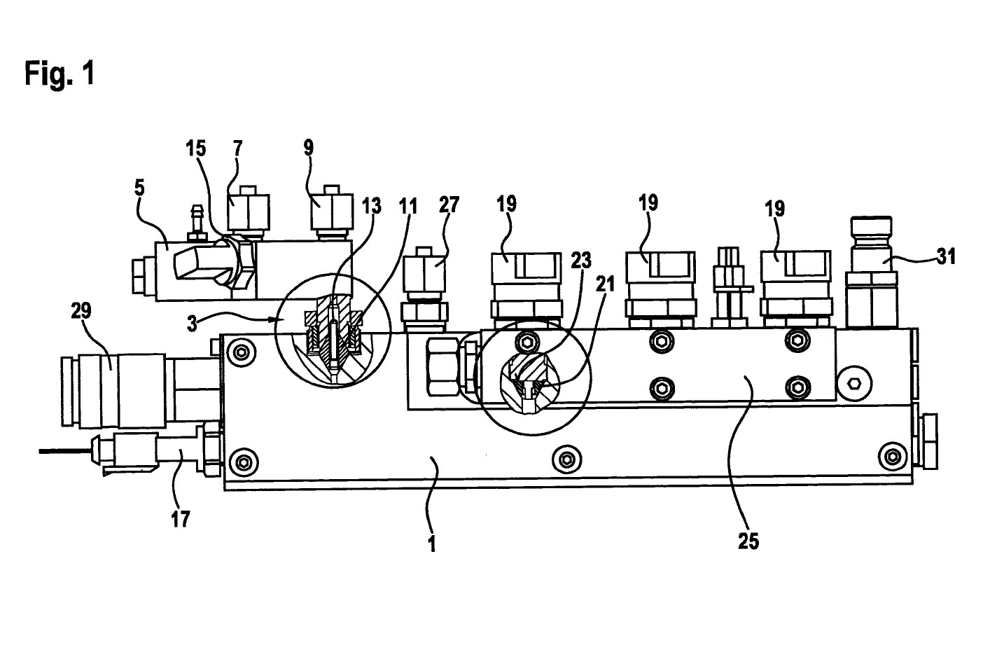

FIG. 1 shows a device for testing high-pressure components.

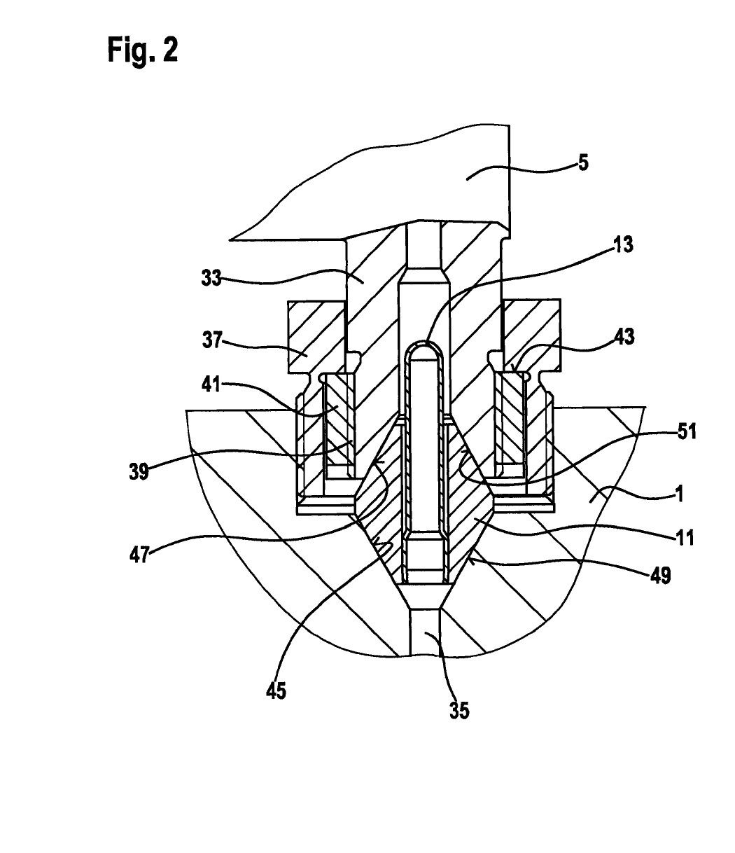

FIG. 2 shows a sealing cone according to the present invention in a first specific embodiment.

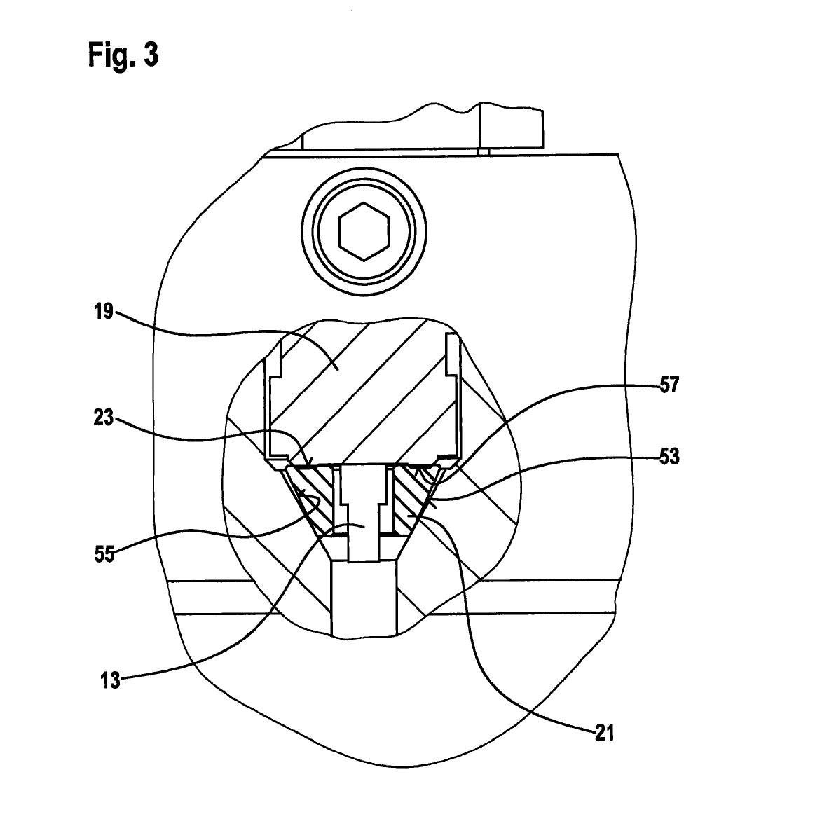

FIG. 3 shows a sealing cone according to the present invention in a second specific embodiment.

### DETAILED DESCRIPTION OF THE INVENTION

FIG. 1 illustrates a device for testing high-pressure components. A device for testing high-pressure components includes a housing 1 in which a high pressure store is accommodated. The high pressure store accommodated in housing 1 is connected to an inlet rail 5 via a first connection 3. The high pressure store is supplied with a liquid which is under pressure via inlet rail 5.

Inlet rail 5 has a first inlet 7 and a second inlet 9 for the liquid which is under pressure.

A sealing cone 11 according to the present invention is accommodated in the connection between inlet rail 5 and the high pressure store. Sealing cone 11 is designed as a double cone. A high-pressure filter 13 is integrated into sealing cone 11.

For indicating clogging of high-pressure filter 13, a first pressure sensor 15 is positioned on inlet rail 5, and a second pressure sensor 17 is positioned on the high pressure store. The pressure of the liquid in inlet rail 5 is measured by first pressure sensor 15. Second pressure sensor 17 measures the pressure in the high pressure store. If there is a pressure difference between inlet rail 5 and the high pressure store, it must be assumed that high-pressure filter 13 is clogged.

In the specific embodiment illustrated here, three pressure control valves 19 are connected to the high pressure store. A second sealing cone 21 is present at the connection between pressure control valve 19 and the high pressure store. In contrast to sealing cone 11 between inlet rail 5 and the high pressure store, second sealing cone 21 between pressure control valve 19 and the high pressure store has a simple tapered design having a flat surface 23 on its top side facing pressure control valve 19. For the sealing, a grip edge is provided on pressure control valve 19 and is pressed against flat surface 23. In the process, the grip edge cuts into flat surface 23, thus forming a media-tight connection.

The outlet of each of pressure control valves 19 opens into a collector 25 in which the exiting liquid under a lower pressure is collected.

In the specific embodiment illustrated here, the device has a connection 27 via which the high pressure store may be connected to another high pressure store having further devices. Liquid under high pressure may be removed from the high pressure store via connection 27.

Since the device heats up due to the high pressure, a cooling system is also provided. For this purpose, a cooling medium is supplied via an inlet 29, flows around the high pressure store inside housing 1, and is removed via an outlet 31. In addition, a uniform temperature of the high pressure store may be achieved by the cooling.

Sealing cone 11, which in the specific embodiment illustrated here is positioned between inlet rail 5 and the high pressure store, is illustrated in detail in FIG. 2.

Inlet rail 5 has a connecting piece 33 which is connected to the high pressure store via an inlet 35.

For the connection, connecting piece 33 is screwed to housing 1 with the aid of a union nut 37.

To be able to mount union nut 37 on connecting piece 33, a thread 39 is formed on connecting piece 33. After union nut 37 is mounted, a pressure ring 41 is screwed onto thread 39. Pressure ring 41 has a top end face 43 on which union nut 37 abuts.

To achieve a media-tight connection, a first seal seat 45 is provided in housing 1 in the area of inlet 35. First seal seat 45 has a conical design. A second, likewise conical seal seat 47 is provided on connecting piece 33. In the specific embodiment illustrated in FIG. 2, sealing cone 11 is designed as a double cone. A first taper 49 of sealing cone 11 abuts first seal seat 45. A second taper 51 of sealing cone 11 abuts second seal seat 47.

To achieve a media-tight connection, first taper 49 of the sealing cone is pressed against first seal seat 45, and second taper 51 of the sealing cone is pressed against second seal seat 47 with the aid of union nut 37.

A media-tight connection is achieved in that the opening angle of first taper 49 and of second taper 51 is 0.5° to 5°, preferably 1° to 3°, in particular 2°, smaller than the opening angle of first seal seat 45 and of second seal seat 47.

By using sealing cone 11 designed as a double cone, it is possible to easily remove high-pressure filter 13 when it becomes soiled. For this purpose, union nut 37 is loosened and inlet rail 5 is taken off. After inlet rail 5 has been taken off, sealing cone 11 is freely accessible and may be removed. High-pressure filter 13 may be cleaned after sealing cone 11 has been removed. After the high-pressure filter is cleaned, sealing cone 11 may be reinserted and screwed in place in a media-tight manner with the aid of union nut 37.

Alternatively, if sealing cone 11 is damaged or if soiling of high-pressure filter 13 is not removable, it is also possible to replace sealing cone 11 with a new sealing cone.

Due to the design of sealing cone 11 having the double cone, the high-pressure components are not damaged by the screwing and the pressure which is thus exerted on tapers 49, 51 of the sealing cone, i.e., the pressure acting on seal seats 45, 47. Regular replacement or regular cleaning of high-pressure filter 13 is thus possible.

In the specific embodiment illustrated in FIG. 2, high-pressure filter 13 is force-fitted into sealing cone 11. Besides a force-fit for introducing pressure filter 13, it is alternatively possible to screw high-pressure filter 13 into sealing cone 11, for example, or to join high-pressure filter 13 to sealing cone 11 using a welding process.

In particular for a high-pressure filter 13 screwed in place, it is possible to remove only high-pressure filter 13 when the filter is soiled or damaged, and replace it with a new high-pressure filter 13. In this case, sealing cone 11 may be reused.

A sealing cone in a second specific embodiment is illustrated in FIG. 3.

In contrast to the sealing cone illustrated in FIG. 2, second sealing cone 21 illustrated in detail in FIG. 3 has a taper 53 having a convex surface. In addition, second sealing cone 21 is not designed as a double cone, but instead has a flat surface 23 which acts as a second sealing surface.

To achieve a media-tight connection, taper 53 having a convex shape is placed against a conical seal seat 55. Due to the convex shape of taper 53, a uniform force acts on seal seat 55 over the periphery of taper 53. It is thus possible to compensate for fairly large tolerances.

To connect pressure control valve 19 in a media-tight manner, grip edges 57 are provided on pressure control valve 19. Grip edge 57 of pressure control valve 19 is pressed against flat surface 23 of sealing cone 11. Grip edge 57 cuts into flat surface 23 of sealing cone 11, thus forming a media-tight connection. However, due to the grip edge it is not possible to use second sealing cone 21 indefinitely. The cutting of grip edge 57 into flat surface 23 results in damage to second sealing cone 21. Second sealing cone 21 is thus used as a wear and tear part which may be replaced.

As an alternative to the specific embodiments illustrated in FIGS. 2 and 3, in the specific embodiment illustrated in FIG. 2, for example, it is possible to use a sealing cone having a conical sealing surface and a flat sealing surface, similar to the illustration in FIG. 3. In this case, a grip edge which cuts into the flat surface of the sealing cone would be provided on connecting piece 33, for example.

Furthermore, as an alternative to first taper 49 and second taper 51, which are designed as cones, it is possible to use a taper having a convex shape, as illustrated in FIG. 3. Alternatively, it is also possible for only first taper 49 or only second taper 51, for example, to have a convex shape.

As an alternative to the specific embodiment illustrated in FIG. 3, it would be possible here to use a sealing cone that is designed as a double cone. In this case, a grip edge would not be provided on pressure control valve 19, and instead, pressure control valve 19 would have to have a conical seal seat.

Instead of the tapers having a convex shape as illustrated in FIG. 3, it is also possible to use a conical taper, as illustrated in FIG. 2.

1-9. (canceled)

10. A device for providing a media-tight connection of two high-pressure components, comprising:
a sealing cone having a central channel through which a medium under high pressure flows;
at least one seal seat into which the sealing cone is pressed in order to seal against the medium which is under high pressure; and
a high-pressure filter accommodated in the central channel of the sealing cone.

11. The device as recited in claim 10, wherein the high-pressure filter is force-fitted into the sealing cone.

12. The device as recited in claim 11, wherein the sealing cone is configured as a taper, and wherein the sealing cone has an opening angle which is 0.5° to 5° smaller than an opening angle of the seal seat.

13. The device as recited in claim 11, wherein the sealing cone has a convex shape.

14. The device as recited in claim 11, wherein:
an external thread is provided on a first high-pressure component;
an enlargement is provided on a second high-pressure component;
the second component is enclosed by a union nut; and
for the media-tight connection, the union nut rests on the enlargement of the second high-pressure component and is screwed onto the first high-pressure component via the thread in such a way that a contact force required for sealing is applied to the sealing cone which is positioned at a connecting point of the first high-pressure component and the second high-pressure component.

15. The device as recited in claim 12, wherein the sealing cone is configured as a double cone.

16. The device as recited in claim 15, wherein a first taper of the double cone is pressed into a first seal seat on a first high-pressure component, and a second taper of the double cone is pressed into a second seal seat on a second high-pressure component.

17. The device as recited in claim 14, wherein the sealing cone is made of a metallic material.

18. The device as recited in claim 12, wherein the first high-pressure component is a high pressure store, and the second high-pressure component is one of a supply line or an inlet to a pressure control valve.
